(19) United States
(12) Patent Application Publication
(10) Pub. No.: US 2024/0085876 A1
(43) Pub. Date: Mar. 14, 2024

(54) ELECTRICAL SYSTEM DEDICATED TO POWER SUPPLY AND CONTROL OF THE ELECTRICAL EQUIPMENT OF A SWIMMING POOL

(71) Applicant: ACWA GROUPE, Saint-Philbert-de-Grand-Lieu (FR)

(72) Inventor: Mikaël LIE, SAINTE HERMINE (FR)

(21) Appl. No.: 18/262,538

(22) PCT Filed: Jan. 20, 2022
(86) PCT No.: PCT/EP2022/051269

§ 371 Date: Jul. 21, 2023

(30) Foreign Application Priority Data
Jan. 22, 2021 (FR) FR2100629

(51) Int. Cl. G05B 19/042

(52) U.S. Cl. CPC G05B 19/042; G05B 2219/2642

(57) ABSTRACT

Disclosed is an electrical system dedicated to power supply and control of the electrical equipment of a swimming pool. The electrical system includes at least one electrical control device suitable for controlling at least one associated piece of electrical equipment. And the at least one electrical control device includes: a drive unit, suitable for controlling the at least one associated piece of electrical equipment; and a wireless communication unit, suitable for integrating the electrical control device to a local area network and suitable for data communication with at least one other electrical control device integrated to the local area network.

### TECHNICAL FIELD OF THE INVENTION

The present invention relates to the technical field of swimming pool equipment and accessories, in particular swimming pool electrical equipment.

In particular, it relates to electrical systems dedicated to power supply and control of the electrical equipment of a swimming pool.

### STATE OF THE ART

A swimming pool conventionally comprises a pool that is associated with an electrical unit for its operation, use and maintenance.

Generally, such an electrical unit is dedicated to the swimming pool in such a way as to comply with the ²constraints and standards relating in particular to the safety of people and equipment.

For that purpose, this electrical unit usually comprises:
electrical equipment dedicated to the swimming pool, generally a pump that is potentially associated with filtration means, lighting means, etc., and
an electrical system for power supply and control of such electrical equipment.

However, the current electrical systems are not optimized in terms of design and coherence.

Indeed, conventionally, a part of the electrical system is implanted within a technical room in a complex/composite form with:
a “swimming pool” electrical box containing the safety devices (generally a pump power safety device, a lighting power safety device and a lighting transformer), and
various separate/independent control devices, external to this “swimming pool” electrical box, which are each dedicated to one piece of the electrical equipment.

Now, in practice, the addition of a new piece of electrical equipment is often tedious and complex.

Indeed, installing a new piece of electrical equipment is equivalent to wiring the electrical box, which is time-consuming and requires technical knowledges.

Moreover, when possible, the interconnection between the pieces of electrical equipment, intended for automation/home automation and safe operation of the installation, must be made by the installer.

Moreover, in practice, it is necessary to intervene frequently in the technical room, in particular to check the good operation of the electrical system and to check the working parameters of the swimming pool (pH, etc.).

### DISCLOSURE OF THE INVENTION

In order to remedy the above-mentioned drawbacks of the state of the art, the present invention proposes an electrical system dedicated to power supply and control of the electrical equipment of a swimming pool.

The electrical system comprises at least one electrical control device suitable for controlling at least one associated piece of electrical equipment.

Said at least one electrical control device is advantageously integrated into at least one box (advantageously waterproof), advantageously connected to a power supply.

And, according to the invention, said at least one electrical control device comprises:
drive means, suitable for controlling said at least one associated piece of electrical equipment,
wireless communication means, suitable for integrating said electrical control device to a local network and suitable for data communication with at least one other electrical control device integrated to said local network.

Such a solution according to the invention thus provides different advantages:
it makes it easier to add one or more piece(s) of electrical equipment as a function of the user's needs,
it allows an inter-behavioural consistency of the pool electrical equipment, advantageously without adding any wiring (local intelligence),
it allows reducing the interventions in the technical local, for the control of the electrical unit,
it potentially makes it possible to propose services (to end customers and/or to professionals), in installation, maintenance or monitoring.

This solution further provides modularity, thanks to the use of a box (potentially waterproof) integrating at least one electrical control device, with a possibility to interconnect several electrical control devices via a network. This architecture thus makes it possible to adapt the finished product to the customers and installation profiles needs.

The invention also allows adding electrical control devices integrating a battery power supply, without wiring, in particular with an electrical box. This solution avoids the need to carry out work to improve the installation in order to control the swimming pool equipment.

Other non-limiting and advantageous features of the product according to the invention, taken individually or according to all the technically possible combinations, are the following:
said at least one electrical control device also comprises means for the connection to a power supply, and/or power supply means, for powering said at least one associated piece of electrical equipment, and/or wired communication means, suitable for integrating said electrical control device to said local network and suitable for wired data communication with at least one other electrical control device integrated to said local network;
the drive means of said at least one electrical control device are structured to control said at least one associated piece of electrical equipment in at least two modes: an “autonomous” mode, for controlling said at least one associated piece of electrical equipment in autonomy, independently of the data communicated within said local network, or a “network” mode, for controlling said at least one associated piece of electrical equipment taking into account data from said local network, and preferably data from at least one other electrical control device integrated to said local network.

According to an advantageous embodiment, said at least one electrical control device is chosen among:
a “filtration” electrical control device, which is suitable for the control and power supply of a pump and/or a motorized valve to ensure water recycling flow,
a “lighting” electrical control device, which is suitable for the control and power supply of lighting means,
a “disinfection” electrical control device, which is suitable for the control and power supply of disinfection means, for example a chlorine injection pump and/or an electrolyser cell,
a “pH” electrical control device, which is suitable for the control and power supply of pH regulation means, for example a pH injection pump,
a “cover” electrical control device, which is suitable for the control and power supply of a motorized cover,
a “counter-current swimming” electrical control device, which is suitable for the control and power supply of counter-current swimming means,
a “heating” electrical control device, which is suitable for the control and power supply of water and/or air heating means, for example in the form of a heat pump (PAC) or a heater,
a first “pump” electrical control device, which is suitable for the control and power supply of air and/or water propelling means, for example an air propeller (blower) or a booster,
a second “pump” electrical control device, which is suitable for the control and power supply of air and/or water suction means,
a “switch” electrical control device, which is suitable for the control and power supply of a switch, for example a piezoelectric button,
a “filling solenoid valve” electrical control device, which is suitable for the control and power supply of a solenoid valve for filling the pool with water,
a “selection solenoid valve” electrical control device, which is suitable for the control and power supply of a solenoid valve for massaging jet/counter-current swimming selection.

According to an advantageous embodiment, said electrical system comprises at least one “master” electrical device, potentially consisted of an electrical control device, designed to concentrate the data communication within said local network for a centralized communication.

Said at least one “master” electrical device is advantageously placed into a main box.

Said at least one “master” electrical device comprises:
means for connection to a power supply,
wireless communication means, suitable for integrating said “master” electrical device to said local network and for concentrating the data within said local network,
potentially, drive means, suitable for controlling said at least one associated piece of electrical equipment, advantageously a pump to ensure water recycling flow, and advantageously suitable for controlling at least one other electrical control device integrated to said local network,
potentially, a user interface.

Preferably, said electrical system comprises:
said at least one “master” electrical device, and
said at least one electrical control device forming a “peripheral” electrical control device, which is suitable for controlling at least one associated piece of electrical equipment and advantageously placed into the main box or in an extension box or in a connected electrical socket or directly in said at least one associated electrical equipment.

Still preferably, the wireless communication means of said at least one “peripheral” electrical control device are structured to ensure at least one communication mode among:
a centralized communication mode, in which said at least one “peripheral” electrical control device is designed to communicate data with at least one other “peripheral” electrical control device via said at least one “master” electrical device, and/or
a decentralized communication mode, in which said at least one “peripheral” electrical control device is designed to directly communicate data with at least one other “peripheral” electrical control device.

According to another particular embodiment, said electrical system is devoid of a “gateway” electrical device or comprises at least one “gateway” electrical device chosen among:
a first “gateway” electronic device, designed to generate a gateway from said local network R to an external network, for example the Internet,
a second “gateway” electronic device, designed to generate a gateway from said local network R to a long-range link,
a third “gateway” electronic device, designed to generate a local gateway from said local network R to a personal electronic device.

Within this framework, preferably, the external network comprises at least one remote server designed to exchange with said local network R for:
the working of at least one electrical control device taking into account external data, and/or
the control of at least one electrical control device via a personal electronic device.

And, according to an advantageous embodiment, said at least one electrical control device is:
irremovable with respect to said at least one box, to form a so-called “all-in-one” unit,
removable with respect to said at least one box, to form a modular unit.

Generally, said electrical system also advantageously comprises at least one sensor that includes:
means for collecting data, suitable for collecting data about at least one working parameter of the swimming pool,
wireless communication means, suitable for integrating said sensor to said local network R and suitable for data communication with at least one other electrical control device integrated to said local network R, and
power supply means, advantageously a battery.

The drive means of at least one electrical control device are structured to control said at least one associated piece of electrical equipment taking into account data from said at least one sensor.

Preferably, said at least one sensor is chosen among:
a hydraulic circuit pressure sensor,
a redox sensor,
a pH sensor,
a water temperature sensor,
an air temperature sensor,
a water level sensor,
a hydraulic circuit flow sensor,
a limit sensor for the pool cover,
an end-of-can detector,
a button, for example a piezoelectric sensor.

Still according to an embodiment, said at least one box advantageously comprises at least one electrical protection device.

The present invention also relates to the electrical control device, for an electrical system dedicated to power supply and control of the electrical equipment of a swimming pool.

The electrical control device comprises:
drive means, suitable for controlling said at least one associated piece of electrical equipment,
wireless communication means, suitable for integrating said electrical control device to a local network R and suitable for data communication with at least one other electrical control device integrated to said local network R,
potentially, means for connection to a power supply,
potentially, power supply means, for powering said at least one associated piece of electrical equipment, and
potentially, wired communication means, suitable for integrating said electrical control device to said local network R and suitable for wired data communication with at least one other electrical control device integrated to said local network R.

The present invention also relates to a sensor for an electrical system dedicated to power supply and control of the electrical equipment of a swimming pool.

The sensor includes:
means for collecting data, suitable for collecting data about at least one working parameter of the swimming pool,
wireless communication means, suitable for integrating said sensor to said local network R and suitable for data communication with at least one other electrical control device integrated to said local network R, and
power supply means, advantageously a battery.

The present invention also relates to the electrical unit for swimming pool, comprising:
the electrical system according to the invention, and
at least one piece of electrical equipment for swimming pool,

said at least one piece of electrical equipment being chosen among:
a pump,
a motorized valve associated with the filtration means,
lighting means,
disinfection means,
pH regulation means,
a motorized cover,
counter-current swimming means,
water and/or air heating means, for example in the form of a heat pump (PAC),
air and/or water propelling means,
air and/or water suction means,
a switch, for example a piezoelectric button,
a solenoid valve for filling the pool with water,
a solenoid valve for massaging jet/counter-current swimming selection.

The present invention also relates to the swimming pool comprising a pool that is fitted with an electrical unit according to the invention.

Obviously, the different features, alternatives and embodiments of the invention can be associated with each other according to various combinations, insofar as they are not incompatible or exclusive with respect to each other.

### DETAILED DESCRIPTION OF THE INVENTION

Moreover, various other features of the invention emerge from the appended description made with reference to the drawings that illustrate non-limiting embodiments of the invention, and wherein:

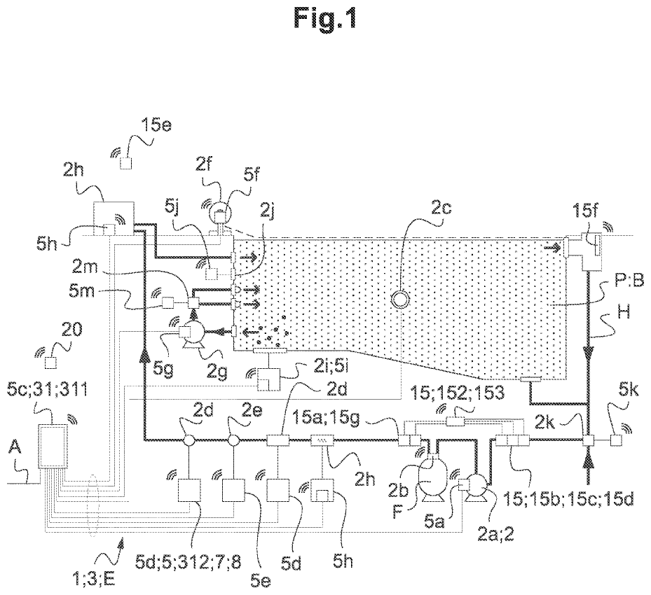

FIG. 1 is a general schematic view of a swimming pool that is fitted with an electrical unit according to the invention;

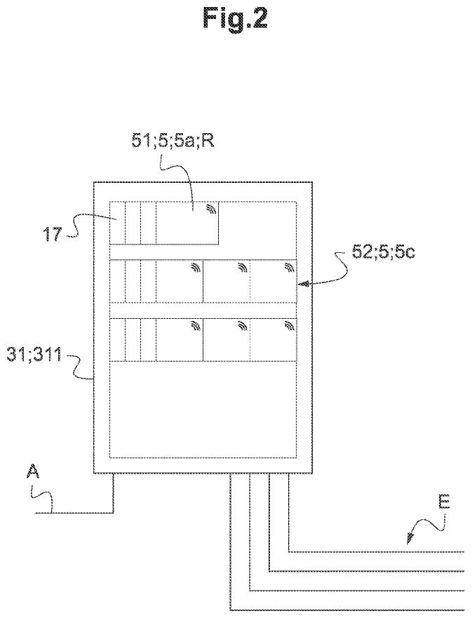

FIG. 2 is a schematic view that illustrates the box of the electrical system and into which are integrated electrical control devices;

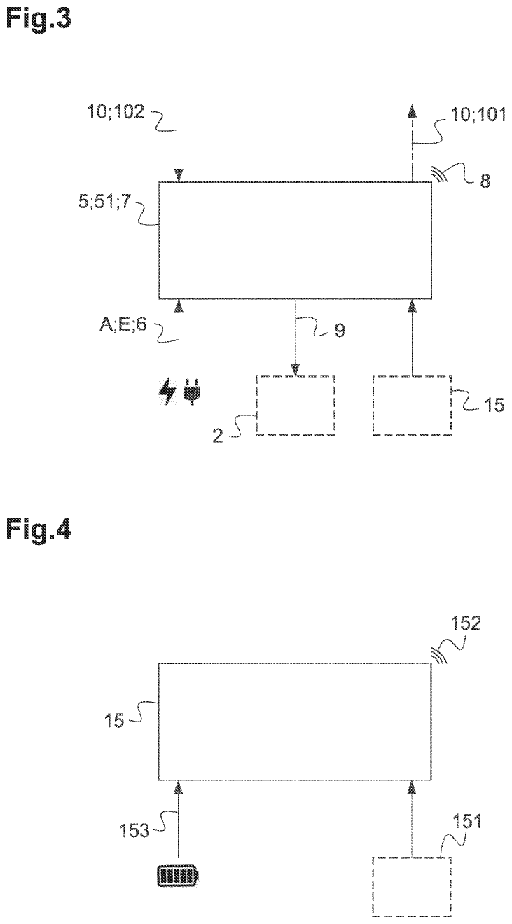

FIG. 3 is a schematic view, in isolation, of an electrical control device according to the invention;

FIG. 4 is a schematic view, in isolation, of a sensor according to the invention.

It is to be noted that, in these figures, the structural and/or functional elements common to the different alternatives may have the same references.

FIG. 1 shows, in a general and schematic view, a swimming pool P whose pool B is fitted with an electrical unit 1 according to the invention.

By “electrical unit”, it is advantageously meant the electrical installation suitable for the environment of a swimming pool and meeting in particular safety and regulatory requirements.

Such an electrical unit 1 advantageously comprises:
at least one piece of electrical equipment 2 for swimming pool, and
an electrical system 3 that is dedicated to power supply and control of said at least one piece of electrical equipment 2.

Electrical Equipment(s)

Generally, as schematically illustrated in FIG. 1, said at least one piece of electrical equipment 2 is advantageously chosen among the electrical equipment 2 conventionally distributed about a swimming pool P for its operation, use and maintenance.

Such a piece of equipment 2 consists for example of:
a pump 2a, also called “filtration pump”, to ensure water recycling flow at filtration means F,
a motorized valve 2b, participating to the control of the water supply to the filtration means F,
lighting means 2c, comprising for example a set of LED bulbs or LED spotlights,
disinfection means 2d, for example in the form of an electrolyser (a device fitted with an electrolysis cell that converts the salt diluted in the pool water into sodium hypochlorite and hydrogen) or a chlorine injector,
pH regulation means 2e, for example a device fitted with a peristaltic pump associated with a pH buffer can/container,
a motorized cover 2f, for example a cover fitted with a motorized drive roller or a shelter made up of movable elements,
counter-current swimming means 2g, advantageously a pump (booster) associated with an outlet nozzle,
water and/or air heating means 2h, for example in the form of a heat pump (also called “PAC”) and/or a heater,
means 2i for propelling air (for example, a blower useful for the spa bubbles, with the air being heated or not) and/or water (for example, for massaging jets),
air and/or water suction means (for example for counter-current swimming and for Venturi system),
a switch 2j, for example a piezoelectric button,
a filling solenoid valve 2k, for controlling the filling of the pool with water,
a selection solenoid valve 2m, for massaging jet/counter-current swimming selection.

The filtration pump 2a is for example a single-phase or three-phase pump, a variable-speed pump, or a pump with a variable-speed drive.

In practice, the swimming pool P is advantageously equipped with at least the filtration pump 2a, alone or in combination with at least one other above-mentioned piece of electrical equipment 2.

The swimming pool P advantageously includes a hydraulic circuit H connected to the pool B by an input/output assembly, fitted in particular with this filtration pump 2a and filtration means F.

Electrical System

The electrical system 3 according to the invention is thus dedicated to the power supply and control of the above-mentioned pieces of electrical equipment 2, in such a way as to provide automation/home automation functions for swimming pools, which are useful for private and/or professional users.

Such a system advantageously complies with standard NF C15-100.

For that purpose, generally, this electrical system 3 comprises at least one electrical control device 5 suitable for controlling at least one associated piece of electrical equipment 2.

By “electrical control device 5”, it is advantageously meant an electrical/electronic device that is adapted to the automatic control, and preferably also the power supply, of at least one associated piece of electrical equipment 2.

This electronic control device 5 thus advantageously forms a drive part of the electrical system 3, for an automatic/programmed control of at least one associated piece of electrical equipment 2.

In other words, at least one piece of electrical equipment 2 is advantageously associated/paired with an electronic control device 5, dedicated to its control, and preferably also its power supply.

Preferably, at least two pieces of electrical equipment 2 are advantageously each associated/paired with an electronic control device 5, dedicated to its control, and preferably also its power supply.

Thus, the electrical system 3 advantageously comprises an electrical control device 5, or a combination of electrical control devices 5, adapted to said at least one piece of electrical equipment 2 present around the pool B.

As illustrated in FIGS. 1 and 2, said at least one electrical control device 5 is advantageously chosen among:
a “filtration” electrical control device 5a, which is suitable for the control and power supply of the filtration pump 2a and/or a motorized valve 2b ensuring the water recycling flow, for example between an ON state, an OFF state and a working program,
a “lighting” electrical control device 5c, which is suitable for the control and power supply of lighting means 2c, for example between an ON state, an OFF state and a working program,
a “disinfection” electrical control device 5d, which is suitable for the control and power supply of the disinfection means 2d, in particular for regulating the water disinfection (for example regulating the water redox potential value in the pool B),
a “pH” electrical control device 5e, which is suitable for the control and power supply of the pH regulation means 2e, in particular for regulating the water pH value of the pool B,
a “cover” electrical control device 5f, which is suitable for the control and power supply of the motorized cover 2f between an open position (retracted) and a closed position (extended),
a “counter-current swimming” electrical control device 5g, which is suitable for the control and power supply of the counter-current swimming means 2g, between an ON state and an OFF state,
a “heating” electrical control device 5h, which is suitable for the control and power supply of the water and/or air heating means 2h, in particular as a function of a water and/or air temperature set point,
a first “pump” electrical control device 5i, which is suitable for the control and power supply of the air and/or water propelling means 2i, for example an air propeller (blower) or a booster,
a second “pump” electrical control device, which is suitable for the control and power supply of the air and/or water suction means,
a “switch” electrical control device 5j, which is suitable for the control and power supply of the switch 2j, for example a piezoelectric button,
a “filling solenoid valve” electrical control device 5k, which is suitable for the control and power supply of the solenoid valve 2k for filling the pool with water,
a “selection solenoid valve” electrical control device 5m, which is suitable for the control and power supply of the solenoid valve 2m for massaging jet/counter-current swimming selection.

Generally, in order to provide the automation/home automation functions, said at least one electrical control device 5 according to the invention is designed to be integrated to a local network R.

By “local network R”, it is advantageously understood a computer network (also called “Local Area Network” or “LAN”), wherein the participating terminals (herein the electrical control devices 5, or also the associated electrical equipment 2 and/or sensors which will be described hereinafter) exchange data, without using access to the Internet.

This local network R advantageously forms a local network R dedicated to the pool P.

For that purpose, according to the invention and as schematically illustrated in FIG. 3, an electrical control device 5 comprises:
potentially, connection means 6, for the connection to a power supply A, E suitable for its operation and potentially the power supply of said at least one associated piece of electrical equipment 2,
drive means 7, suitable for controlling said at least one associated piece of electrical equipment 2,
wireless communication means 8, suitable for integrating said electrical control device 5 to a local network R and suitable for data communication with at least one other electrical control device 5 integrated to said local network R, and
potentially, power supply means 9, for powering said at least one associated piece of electrical equipment 2,
potentially, wired communication means, suitable for integrating said electrical control device 5 to said local network R and suitable for wired data communication with at least one other electrical control device 5 integrated to said local network R.

As an alternative, the electrical control device 5 can be devoid of wire communication means.

The electrical control device 5 thus advantageously comprises an assembly of several electronic boards, wherein at least one of said electronic boards can include a power supply, a radio module, a programmable calculation function, inputs/outputs and a storage module.

The connection means 6 and the power supply means 9 advantageously consist of electrical connection elements, conventional per se.

These connection means 6 and these power supply means 9 consist for example of plug-in cables or electrical plugs (male or female).

The wireless communication means 8 are for example chosen, only by way of example, among short- or medium-range wireless communications, for example Bluetooth LE, ZigBee or THREAD (CHIP).

The wireless communication means 8 are thus suitable for integrating said electrical control device 5 to the local network R.

In other words, each electrical control device 5 advantageously includes wireless communication means 8 for its integration to the local network R.

Moreover, the drive means 7 advantageously comprise a microcontroller in which is stored a computer program containing instructions that, when said computer program is executed by said microcontroller, cause the latter to control said at least one associated piece of electrical equipment 2 according to a dedicated algorithm.

Generally, the drive means 7 of an electrical control device 5 can be structured to control said at least one associated piece of electrical equipment 2 in at least two modes:
an “autonomous” mode, for controlling said at least one associated piece of electrical equipment 2 in autonomy, independently of the data communicated within said local network R (without taking into account data from the local areal network R), or
a “network” mode, for controlling said at least one associated piece of electrical equipment 2 taking into account data from the local network R, and preferably data from at least one other electrical control device 5 integrated to said local network R.

In “network” mode, the drive means 7 thus advantageously take into account data from terminals that participate to the local network R, herein potential other electrical control devices 5 in presence, or even also associated electrical equipment 2 and/or sensors that will be described hereinafter.

In other words, the drive means 7 of an electrical control device 5 can advantageously include several modules/functions that are called/activated as a function of terminals that participate to the local network R (herein the electrical control devices 5, or even also associated electrical equipment 2 and/or sensors that will be described hereinafter).

In still other words, the drive means 7 of an electrical control device 5 can control said at least one associated piece of electrical equipment 2 according to an algorithm that is adapted as a function of the terminals that participate to the local network R.

This solution based on a local network R, and algorithms within each of the electrical control devices 5, allows each of the electrical control devices 5 to improve its own services through knowledge of information/data transmitted by said at least one electrical control device 5 in presence.

Only by way of non-limiting example, the following automatism algorithms can be implemented via the interconnection to implement the following slave controls:
when the pool cover is closed, the light is switched off to save wasted energy, and the speed of the filtration pump is reduced,
enslaving the “heating” electrical control device 5h to the “filtration” electrical control device 5a (or the reverse),
enslaving the “disinfection” electrical control device 5d to the “filtration” electrical control device 5a (or the reverse),
enslaving the “disinfection” electrical control device 5d to the “cover” electrical control device 5f,
enslaving the “disinfection” electrical control device 5d to the “pH” electrical control device 5e.

According to a preferred embodiment, as described hereinafter still in relation with FIGS. 2 and 3, the electrical system 3 can comprise at least one “master” electrical control device 51 (also called “coordinator”) which is intended to concentrate the transmissions within the local network R for a centralized communication.

This “master” electrical control device 51 is in particular useful to create the local network R.

The “master” electrical control device 51 may be consisted by an above-mentioned electrical control device 5, for example by the “filtration” electrical control device 5a.

As an alternative, the “master” electrical control device 51 can be separate/independent from the above-mentioned electrical control devices 5. This “master” electrical control device 51 thus forms a dedicated “master” electrical control device 51.

As described in relation with FIG. 3, a “master” electrical control device 51 comprises for that purpose:
means 6 for connection to a power supply,
wireless communication means 8, suitable for integrating said “master” electrical control device 51 to the local network R and for concentrating the data within said local network R,
as the case may be, drive means 7, suitable for controlling said at least one associated piece of electrical equipment 2, advantageously the filtration pump 2a, and advantageously suitable for controlling at least one other electrical control device 5 integrated to said local network R, and
potentially, a user interface 10, i.e., for example a screen 101 with buttons 102.

Within this framework, according to FIG. 2, said electrical system 3 advantageously comprises:
said at least one “master” electrical control device 51, and
at least one other electrical control device 5 forming a “peripheral” electrical control device 52, which is suitable for controlling at least one associated piece of electrical equipment 2.

The wireless communication means 8 of said at least one “peripheral” electrical control device 52 are advantageously structured to ensure at least one communication mode among:
a centralized communication mode, in which said at least one “peripheral” electrical control device 52 is designed to communicate data with at least one other “peripheral” electrical control device 52 via said at least one “master” electrical device 51, and/or
a decentralized communication mode, in which said at least one “peripheral” electrical control device 52 is designed to directly communicate data with at least one other “peripheral” electrical controlling device 52.

In the “centralized” method, said at least one “master” electrical device 51 concentrates the transmissions. It is also used for Internet communication via the gateway or telephone, and for taking decisions (local intelligence).

In the “decentralized” method, the communication is made between “peripheral” electrical control devices 52. It allows each product to offer complementary services thanks to the information of the other products.

Generally, said at least one electrical control device 5 can be integrated to at least one box 31, advantageously waterproof, advantageously connected to a power supply.

Preferably:
said at least one “master” electrical device 51 can be integrated into a main 31, and
said at least one “peripheral” electrical control device 52 can be integrated into at least one box 31 or be separate from said at least one box 31 (for example, in the form of an electrical socket connected to or directly integrated into the associated piece of electrical equipment 2).

Said at least one electrical control device 5 can advantageously take two forms with respect to said at least one box 31, i.e., “irremovable” and “removable”.

Said at least one electrical control device 5 can thus be irremovable with respect to its box 31, to form an “all-in-one” unit.

In other words, a box 31 advantageously integrates a combination of electrical control devices 5, for example:
a “filtration” electrical control device 5a, and
a “lighting” electrical control device comprises 5c.

As an alternative, said at least one electrical control device 5 can thus be removable with respect to its box 31, to form a modular unit.

In this case, the electrical system 3 is advantageously in the form of a specialized panel, preferably pre-fitted, that is designed to control at least part of the pieces of electrical equipment 2 of the pool P, or even all the pieces of electrical equipment 2.

This specialized panel advantageously includes at least one row for the positioning of each electrical control device 5 in the form of at least one modular apparatus or at least one modular product.

According to a particular embodiment, as illustrated in FIG. 1, the electrical system 3 may include:
a single box 31, or
several waterproof boxes 31, with a first main box 311, and at least one second, extension box 312, in which are distributed the electrical control devices 5.

The first box 311 can form a base casing that receives the general power supply and that contains the basic functions, for example pump and lighting. The second box 312 is a casing added a posteriori, whose object is for example to extend the functions of the electrical system in the case where the first box 311 would become insufficient (available room).

Said at least one “master” electrical device 51 is advantageously implanted in the first, main box 311; said at least one other “peripheral” electrical control device 52 can be added in the main box 311 or in an extension box 312.

As an alternative or a complement, a “peripheral” electrical control device 52 can be in the form of a connected electrical socket 312 (denoted by the same reference as the second box 312, for the sake of simplification, with reference to FIG. 1).

Said at least one “master” electrical device 51 is advantageously placed in the first, main box 311.

In relation with FIG. 1, said at least one connected electrical socket 312 is thus interposed between:
the power supply electrical circuit E coming from the first box 311, and
the electrical equipment 2 to be controlled.

Such connected electrical sockets 312 have for interest to extend, in a simple way, the functions of the electrical system 3.

In such a connected electrical socket 312, the electrical control device 5 also advantageously comprises:
the connection means 6, for connection to the power supply electrical circuit E of the first box 311, suitable for its operation and the power supply of said at least one associated piece of electrical equipment 2, for example in the form of a male electrical plug intended to be connected to a female electrical plug said power supply electrical circuit E is fitted with,
drive means 7, suitable for controlling said at least one associated piece of electrical equipment 2 (for example, a control of the power supply of the associated piece of electrical equipment 2),
wireless communication means 8, suitable for integrating said electrical control device 5 to a local network R and suitable for data communication with at least one other electrical control device 5 integrated to said local network R,
power supply means 9 intended for powering said at least one associated piece of electrical equipment 2, for example in the form of a female electrical plug intended to be connected to a male electrical plug fitted on the associated piece of electrical equipment 2, and
potentially, wired communication means, suitable for integrating said electrical control device 5 to said local network R and suitable for wired data communication with at least one other electrical control device 5 integrated to said local network R.

According to still another embodiment, said at least one other “peripheral” electrical control device 52 can be incorporated directly into the electrical equipment 2 to be controlled.

Generally, said at least one electrical control device 5 can be responsible for the distribution and required electrical protection for the pieces of electrical equipment 2 of the swimming pool.

In this respect, said at least one box 31 can be adapted to be connected to a power supply A (FIGS. 1 and 2), advantageously coming from a main switch panel (not shown).

Preferably, the first main box 311 is connected to the main switch box; the extension box 312 or the connected electrical socket 312 is connected to the first box 311 by a power supply circuit E (FIG. 1).

Said at least one box 31 is advantageously located in a technical room, near the pool B of the swimming pool P.

Moreover, the box 31 (preferably, a main box 311) also advantageously comprises at least one electrical protection device 17 that is intended to advantageously protect the people, the electrical control devices 5 and/or the associated electrical equipment 2.

For example, the box 31 can include a combination of electrical protection device 17:
a circuit breaker that protects the electrical control devices 5 of the box 31,
a circuit breaker protecting the filtration pump 2a against overloads, short-circuits.

Sensor(s)

The control of some at least of the pieces of electrical equipment 2 is advantageously based on working parameters of the swimming pool P.

For that purpose, the electrical system 3 also advantageously comprises at least one sensor 15, preferably autonomous, designed to pick up such working parameters of the swimming pool P.

Such an “autonomous” sensor allows a customized positioning for an optimum collection of data about the working parameter of interest.

Such sensors 15, advantageously optional, are useful for the feedback of information towards said at least one electrical control device 5 and for the optimum control of associated pieces of electrical equipment 2.

As described hereinafter in relation with FIG. 4, a sensor 15 according to the invention advantageously includes:
data collection means 151, suitable for collecting data about at least one working parameter of the swimming pool P,
wireless communication means 152, suitable for integrating said sensor 15 to said local network R and suitable for data communication with at least one other electrical control device 5 integrated to said local network R, and
power supply means 153, advantageously a battery.

Preferably, this sensor 15 comprises a microcontroller in which is stored a computer program containing instructions that, when said computer program is executed by said microcontroller, cause the latter to control said sensor 15 according to a dedicated algorithm.

Herein, according to FIG. 1, said at least one sensor 15 is advantageously chosen among:
a hydraulic circuit pressure sensor 15a, for measuring the filtration hydraulic circuit pressure,
a redox sensor 15b, for measuring the water disinfection state,
a pH sensor 15c, for measuring the water pH,
a water temperature sensor 15d, and
an air temperature sensor 15e.

Said at least one sensor 15 can also be chosen among:
a swimming pool water level sensor 15f,
a hydraulic circuit flow sensor 15g, for detecting a circulation fault,
a limit sensor (not shown) for the pool cover 2f, to check its closed state or open state,
at least one end-of-treatment product detector, for pH and/or chlorine,
a button, for example a piezoelectric sensor, generally immersed in the pool (for example, to start the massage jets or a counter-current swim, turn the lighting on/off, etc.).

According to an embodiment, the wireless communication means 152 and the power supply means 153 can be common for several sensors 15.

For example, in FIG. 1, the wireless communication means 152 and the power supply means 153 are common to:
the hydraulic circuit pressure sensor 15a,
the redox sensor 15b, for measuring the water disinfection state,
the pH sensor 15c, for measuring the water pH,
the water temperature sensor 15d, and
the hydraulic circuit flow sensor 15g.

Generally, in the presence of a sensor 15, the drive means 7 of at least one electrical control device 5 are structured to control said at least one associated piece of electrical equipment 2 taking into account data from said sensor 15.

In other words, the drive means 7 of an electrical control device 5 can control said at least one associated piece of electrical equipment 2 according to an algorithm that is adapted as a function of the sensor(s) 15 that participate to the local network R.

For example:
when the water temperature is too low, the electrolyser is switched off to save wasted energy,
when the pool cover is closed, the light is switched off to save wasted energy, and the speed of the filtration pump is reduced,
enslaving the “filtration” electrical control device 5a to water temperature,
enslaving the “filtration” electrical control device 5a to air temperature,
enslaving the “disinfection” electrical control device 5d to water temperature,
enslaving the “heating” electrical control device 5h to water temperature,
enslaving the “disinfection” electrical control device 5d to the redox sensor 15b,
enslaving the “pH” electrical control device 5e to the pH sensor.

Gateway

Still according to a particular embodiment, very schematically shown in FIG. 1, the electrical system 3 can comprise at least one “gateway” electrical device 20 that is useful for example for managing the pool via a personal, local or remote electronic device.

This approach then offers a complete interface to drive, control and secure the electrical unit 1 of the swimming pool P.

In this respect, said at least one “gateway” electrical device is advantageously chosen among:
a first “gateway” electronic device, designed to generate a gateway from the local network R to an external network, for example the Internet, useful for remote management of the swimming pool P,
a second “gateway” electronic device, designed to generate a gateway from the local network R to a long-range link, interesting in particular to overcome the wireless signal range issues (for example if the technical room is remote from the swimming pool),
a third “gateway” electronic device, designed to generate a local gateway from the local network R to a personal electronic device, for example a portable phone or a personal computer or an electronic tablet or a voice assistant.

Generally, the “gateway” electrical device 20 is advantageously installed at the home gateway, commonly called “Internet box”, or close to the area of use of the pool with the personal electronic device, or outside to pick up a LoRaWan signal.

In practice, the above-mentioned “gateway” electronic devices are respectively based on wireless telecommunication technologies which are chosen in particular as a function of the desired signal range.

The first “gateway” electronic device advantageously comprises two wireless communication modules, for example WiFi and/or Ethernet, Bluetooth and ZigBee or Thread (CHIP), with:
a first communication module fitted to a box 31, and
a communication module connected to the gateway/home router connected to the Internet (commonly called “Internet box”).

Moreover, the second “gateway” electronic device, not shown, uses for example SigFox or LoraWan; the third “gateway” electronic device is for example based on a WiFi or Bluetooth technology.

The third “gateway” electronic device allows a local connectivity, offering a local interactivity service (only on the consumer's site) between the end consumer and the electrical system 3.

Generally, the “gateway” electrical device 20 consists of a separate electrical device with respect to the electrical control devices 5.

For the remote control, the user (private or professional) advantageously accedes to a Web application or to a mobile application (also called “application software developed for a mobile electronic device”) via a personal electronic device, for example a portable phone or a personal computer or an electronic tablet or a voice assistant.

The user can then:
drive and control the electrical unit 1 of the swimming pool P, in particular to control the electrical equipment 2 (lighting, filtration, etc.), and/or
receive alerts in case of detected events (for example, lack of water, risk of freezing, filter clogging, circulation fault, water temperature/redox/pH safety threshold, information on empty containers, etc.).

Moreover, the above-mentioned external network advantageously comprises at least one remote server designed to exchange with the local network R.

These exchanges are advantageously designed for:
the operation of at least one electrical control device 5 taking into account external data (for example weather, geographical location, local water properties, etc.), and/or
the control of at least one electrical control device 5 via a personal electronic device.

The presence of a local network R, the first “gateway” electronic device, algorithms within the electrical control devices 5, a remote server and “server” algorithms, makes it possible to improve service provision through a global analysis of the data collected locally, combined with the above-mentioned external data.

Of course, various other modifications may be made to the invention within the scope of the appended claims.

1. An electrical system dedicated to power supply and control of the electrical equipment of a swimming pool,
wherein the electrical system (3) comprises at least one electrical control device (5) suitable for controlling at least one associated piece of electrical equipment (2),
wherein said at least one electrical control device (5) comprises:
drive means (7), suitable for controlling said at least one associated piece of electrical equipment (2),
wireless communication means (8), suitable for integrating said electrical control device (5) to a local network (R) and suitable for data communication with at least one other electrical control device (5) integrated to said local network (R).

2. The electrical system according to claim 1, wherein said at least one electrical control device (5) also comprises:
connection means (6) for connection to a power supply, and/or
power supply means (9), suitable for powering said at least one associated piece of electrical equipment (2), and/or
wired communication means, suitable for integrating said electrical control device (5) to said local network (R) and suitable for wired data communication with at least one other electrical control device (5) integrated to said local network (R).

3. The electrical system according claim 1, wherein the drive means (7) of said at least one electrical control device (5) are structured to control said at least one associated piece of electrical equipment (2) according to at least two modes:
an “autonomous” mode, for controlling said at least one associated piece of electrical equipment (2) in autonomy, independently of the data communicated within said local network (R), or
a “network” mode, for controlling said at least one associated piece of electrical equipment (2) taking into account the data from said local network (R).

4. The electrical system according to claim 1, wherein said at least one electrical control device (5) is chosen among:
a “filtration” electrical control device (5a), which is suitable for the control and power supply of a pump (2a) and/or a motorized valve (2b) to ensure water recycling flow,
a “lighting” electrical control device (5c), which is suitable for the control and power supply of lighting means (2c),
a “disinfection” electrical control device (5d), which is suitable for the control and power supply of disinfection means (2d),
a “pH” electrical control device (5e), which is suitable for the control and power supply of pH regulation means (2e),
a “cover” electrical control device (5f), which is suitable for the control and power supply of a motorized cover (2f),
a “counter-current swimming” electrical control device (5q), which is suitable for the control and power supply of counter-current swimming means (2g),
a “heating” electrical control device (5h), which is suitable for the control and power supply of water and/or air heating means (2h),
a first “pump” electrical control device (5i), which is suitable for the control and power supply of air and/or water propelling means (2i),
a second “pump” electrical control device, which is suitable for controlling and powering air and/or water suction means,
a “switch” electrical control device (5j), which is suitable for the control and power supply of a switch (2j), for example a piezoelectric button,
a “filling solenoid valve” electrical control device (5k), which is suitable for the control and power supply of a solenoid valve (2k) for filling the pool with water,
a “selection solenoid valve” electrical control device (5m), which is suitable for the control and power supply of a solenoid valve (2m) for massaging jet/counter-current swimming selection.

5. The electrical system according to claim 1, wherein said electrical system (3) comprises at least one “master” electrical device (51), designed to concentrate the data communication within said local network for a centralized communication,
said at least one “master” electrical device (51) comprising:
connection means (6) for connection to a power supply,
wireless communication means (8), suitable for integrating said “master” electrical device (51) to said local network (R) and for concentrating the data within said local network (R).

6. The electrical system according to claim 5, wherein said electrical system (3) comprises:
said at least one “master” electrical device (51), and
said at least one electrical control device (5) forming a “peripheral” electrical control device (52), which is suitable for controlling at least one associated piece of electrical equipment (2).

7. The electrical system according to claim 6, wherein the wireless communication means (8) of said at least one “peripheral” electrical control device (52) are structured to ensure at least one communication mode among:
a centralized communication mode, wherein said at least one “peripheral” electrical control device (52) is designed to communicate data with at least one other “peripheral” electrical control device (52) via said at least one “master” electrical device (51), and/or
a decentralized communication mode, in which said at least one “peripheral” electrical control device (52) is designed to directly communicate data with at least one other “peripheral” electrical control device (52).

8. The electrical system according to claim 1, wherein said electrical system (3) is devoid of a “gateway” electrical device or comprises at least one “gateway” electrical device (20) chosen among:
a first “gateway” electronic device, designed to generate a gateway from said local network (R) to an external network,
a second “gateway” electronic device, designed to generate a gateway from said local network (R) to a long-range link,
a third “gateway” electronic device, designed to generate a local gateway from said local network (R) to a personal electronic device.

9. The electrical system according to claim 8, wherein the external network comprises at least one remote server designed to exchange with said local network (R) for:
the working of at least one electrical control device (5) taking into account external data, and/or
the control of at least one electrical control device (5) via a personal electronic device.

10. The electrical system according to claim 1, wherein said at least one electrical control device (5) is:
irremovable with respect to said at least one box (31), to form a so-called “all-in-one” unit,
removable with respect to said at least one box (31), to form a modular unit.

11. The electrical system according to claim 1, wherein said electrical system (3) also comprises at least one sensor (15) that includes:
means for collecting data (151), suitable for collecting data about at least one working parameter of the swimming pool,
wireless communication means (152), suitable for integrating said sensor (15) to said local network (R) and suitable for data communication with at least one other electrical control device (5) integrated to said local network (R), and
power supply means (153),
and wherein the drive means (7) of at least one electrical control device (5) are structured to control said at least one associated piece of electrical equipment (2) taking into account data from said at least one sensor (15).

12. An electrical control device, for an electrical system (3) dedicated to power supply and control of the electrical equipment of a swimming pool,
said electrical control device (5) comprising:
drive means (7), suitable for controlling said at least one associated piece of electrical equipment (2),
wireless communication means (8), suitable for integrating said electrical control device (5) to a local network (R) and suitable for data communication with at least one other electrical control device (5) integrated to said local network (R),
means (6) for connection to a power supply,
power supply means (9), for powering said at least one associated piece of electrical equipment (2), and
wired communication means, suitable for integrating said electrical control device (5) to said local network (R) and suitable for wired data communication with at least one other electrical control device (5) integrated to said local network (R).

13. A sensor for an electrical system (3) dedicated to power supply and control of the electrical equipment of a swimming pool,
said sensor (15) including:
data collection means (151), suitable for collecting data about at least one working parameter of the swimming pool,
wireless communication means (152), suitable for integrating said sensor to said local network (R) and suitable data communication with at least one other electrical control device (5) integrated to said local network (R), and
power supply means (153).

14. An electrical unit for swimming pool, comprising:
the electrical system (3) according to claim 1, and
at least one piece of electrical equipment (2) for swimming pool,
said at least one piece of electrical equipment (2) being chosen among:
a pump (2a),
a motorized valve (2b) associated with the filtration means,
lighting means (2c),
disinfection means (2d),
pH regulation means (2e),
a motorized cover (20,
counter-current swimming means (2g),
water and/or air heating means,
air and/or water propelling means (2i),
air and/or water suction means,
a switch (2j),
a solenoid valve (2k) for filling the pool with water,
a solenoid valve (2m) for massaging jet/counter-current swimming selection.

15. A swimming pool comprising a pool (B) which is fitted with an electrical unit (1) according to claim 14.

16. The electrical system according claim 3, wherein, in “network” mode, controlling said at least one associated piece of electrical equipment (2) taking into account the data from said local network (R) and data from at least one other electrical control device (5) integrated to said local network (R).

17. The electrical system according to claim 5, wherein said electrical system (3) comprises at least one “master” electrical device (51) consisted of an electrical control device (5).

18. The electrical system according to claim 5, wherein said at least one “master” electrical device (51) comprising:
drive means (7), suitable for controlling said at least one associated piece of electrical equipment (2),
a user interface (10).
